(19) United States
(12) Patent Application Publication
(10) Pub. No.: US 2006/0249447 A1
(43) Pub. Date: Nov. 9, 2006

(54) Solvent-resistant composite membrane composition

(76) Inventor: Gary Yeager, Rexford, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 11/405,159

(22) Filed: Apr. 17, 2006

Related U.S. Application Data
(62) Division of application No. 11/122,308, filed on May 4, 2005.

(51) Int. Cl. B01D 71/06

(52) U.S. Cl. 210/506; 210/500.27; 210/490; 427/245; 427/352; 427/337

(57) ABSTRACT

A solvent-resistant composite membrane composition comprising polymer coated uniformly on porous filtration membranes can be used in a membrane separation process. The polymer compositions may further comprise comonomers, crosslinking monomers, catalysts, thickening agents, or other additives.

### FIELD OF THE INVENTION

This invention relates to solvent-resistant composite membranes comprising polymer compositions that are coated uniformly on porous filtration membranes. Suitable polymer compositions may comprise comonomers, crosslinking monomers, catalysts, thickening agents, or other additives.

### BACKGROUND

Composite membranes are used in a variety of separation processes such as nanofiltration, pervaporation, perstraction and the like. These composite membranes comprise a dense upper layer of polymer coated on a porous membrane support which may be supported by a fibrous mat. An important goal in the fabrication process for these composite membranes is the uniform thickness of the polymer coated onto the surface of the porous membrane. This can be achieved by the steps of contacting the porous membrane support with a solution of the polymer, and removing the solvent by heat. Optionally, the step of curing the polymer can be added before the removal of the solvent. This fabrication process results in a thin film membrane that is uniformly coated on the porous support.

To achieve high fluxes in filtration processes using composite membranes, the polymer coating on the composite membranes should be thin. One suitable method is to use a diluted solution of the organic polymer when coating the surface of the porous support. After the solvent is evaporated, a thin film of polymer remains coated onto the surface of the porous membrane. The thickness of the ultra thin film is therefore determined by the concentration of the polymer solution.

Even at low concentration, the viscosity of the polymer solution is still low, and the flow and fill control of the polymer solution on the porous support is less controllable. As a result, the layer of polymer is thicker than desirable. Also, certain polymers such as silicones may negatively impact the fluxes of the membranes. During the coating of the porous support with polymers, such as the fluoropolymers, the cohesive forces within the polymers may be stronger than the adhesive forces between the polymer and the membrane. As a result, beading of the polymer coating may occur, resulting in an uneven coating on the surface of the porous support.

U.S. Pat. No. 5,670,052 to Ho et al. relates to partially crosslinked polyimide-ester-epoxy copolymers on a porous polytetrafluoroethylene membrane. The monomers were polymerized and crosslinked in solution to produce dilute solutions with viscosities high enough that penetration into the porous support was minimized and thin film membranes were prepared. However, as crosslinking occurred rapidly, viscosity of the polymer solution was not easily controllable, resulting in varying thickness of the thin film. U.S. Pat. Nos. 6,017,455 and 5,997,741 to Shimoda et al. relate to the use of thickening agents to prepare anisotropic porous polyether ketone and poly(ether ketone ketone) membranes. U.S. Pat. No. 6,551,684 to Solomon et al. relates to a polymeric membrane system such that the polymer resides within the interstitial space of the porous membrane. The '684 patent also relates to the use of thickening agent to control viscosity. U.S. Pat. Nos. 3,926,798, 4,626,468 and 4,830,885 relate to the use of interfacial polymerization in preparing thin film membranes, involving the sequential coating of an organic hydrocarbon solution of a first comonomer and an aqueous solution of a second monomer reactive with the first. Materials that can be used include trimellitic acid chloride and o- and p-phenylenediamine. The polymerization occurs at the interface (i.e. surface of the porous support), producing a thin polyamide membrane. However, this process is generally limited to using the polymers that are soluble in organic solvents, and the polymers that are soluble in aqueous solvents. Merkel et al. in Science 1998 Mar. 13; 279: 1710-1711 describes the addition of fumed silica to “super-glassy” polymers (e.g. poly(4-methyl-2-pentyne)) to produce membranes with reverse selectivity in gas separations. However, such membranes either do not have the solubility characteristics, or are not resistant to solvent attack. Hence, there remains a need to produce thin film composite membranes using dilute polymer solutions.

### SUMMARY

Briefly, in accordance with one embodiment of the present invention, a solvent-resistant composite membrane composition comprises a coating of a monomer or a polymer, and a thickening agent. The coating on the porous support forms a membrane suitable for separation.

In accordance with another embodiment of the invention, a method of preparing a solvent-resistant membrane comprising the steps of dissolving a monomer or a polymer in a solvent to form a coating solution, adding a thickening agent to the coating solution, contacting the coating solution with a porous support to form a coating, and removing the solvent, whereby the coating has a thickness of 3 mils to 10 mils. Additionally, the method may further comprise the step of curing the monomer or the polymer on the porous support to form a composite membrane.

### BRIEF DESCRIPTION OF DRAWINGS

These and other features, aspects, and advantages of the present invention will become better understood when the following detailed description is read with reference to the accompanying drawings in which like characters represent like parts throughout the drawings, wherein:

FIG. 1 is a cross-sectional view of a composite membrane.

FIG. 2 is a flow chart depicting a method preparing a solvent-resistant membrane according to the invention.

FIGS. 3A and 3B illustrate the effects of fumed silica thickener on the coating of polycarbonate dimethacrylate on porous polytetrafluoroethylene support.

### DETAILED DESCRIPTION OF EXEMPLARY EMBODIMENTS

This invention relates to composite membrane compositions suitable for membrane separation processes such as hyperfiltration, pervaporation, perstraction and the like. These composite membranes are also known as thin film membranes, or ultrafiltration membranes. In one embodiment, the invention relates to a composite membrane composition of a low viscosity polymer, preferably a crosslinked polymer, such that the composite membrane composition does not penetrate the pores of a porous substrate. Rather, the composite membrane composition can be readily and uniformly coated on the porous substrate to form a composite membrane. The composite membrane composition may further comprise a comonomer, a crosslinking monomer, catalysts, drying agents, thickeners, other additives known in the art of membrane manufacture or a combination thereof. Preferably, the inventive composition comprises (1) a monomer or polymer useful in the separation of organic solvents, (2) a thickening agent, and/or (3) a solvent.

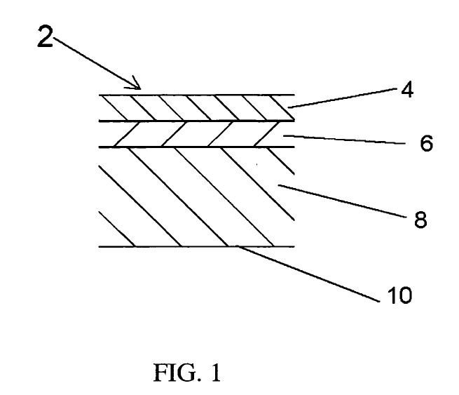

Referring to FIG. 1, the composite membrane comprises a top surface 2, a polymer layer or an ultra-thin film 4, a porous support 6, a backing layer or a fabric 8, and a bottom surface 10.

In another embodiment, this invention relates to a method of preparing a composite membrane comprising the steps of dissolving a monomer or a polymer useful in the separation of organic solvents to form a solution, contacting the solution with a porous support, and removing the solvent from the coated solution. Additionally, the steps of adding a thickener, and curing the monomer may be incorporated into the method.

A membrane separation system generally comprises a barrier and a support that separates phases and chemicals in a selective manner. The membrane separation system separates an incoming solution into a permeate, the part that has passed through the membrane, and a concentrate, the part that has been rejected by the membrane. See “Membrane Separation Processes—Technology and Business Opportunities,” available at hppt://www.tifac.org.in/news/memb.htm. The common membrane separation processes include: reverse osmosis (“RO”), nanofiltration (“NF”), ultrafiltration (“UF”), microfiltration (“MF”), electrodialysis (“ED”), gas separation (“GS”), and pervaporation.

The term “porous” applies to a support material having a surface pore size preferably in the range of about 50 angstroms to about 5000 angstroms. The pore sizes should be sufficiently large so the permeate solvent can pass through the support without reducing the flux of the composite.

The “flux” of a membrane is defined as the amount of permeate produced per unit area of membrane surface per unit time. Flux is expressed as gallons per square foot per day (GFD) or as cubic meters per square meters per day. See “Back to Basics, Ultrafiltration” by G. Dhawan, available at http:/www.appliedmembranes.com/about ultrafiltration.htm. However, the pores should not be so large that the permselective polymer membrane will either be unable to bridge or form across the pores. U.S. Pat. Nos. 4,814,082 to Wrasidlo and 4,783,346 to Sundet are illustrative of methods of choosing and preparing a porous support for interfacial TFC formation included herein by reference.

Solvent-resistant polymers and membranes are needed to carry out membrane separation processes in non-aqueous systems. These solvent-resistant polymers and membranes are required to be stable at low and high temperatures and therefore are prepared from high polymers such as polyimide, poly(amide-imide), polyphosphazene, etc. See “Novel Membrane Processes for Separation of Organics” by Razdan et al., Current Science, Vol. 85, 761-771, 2003, available at http:/www.ias.ac.in/currsci/sep252003/761.pdf, incorporated by reference in its entirety.

In principle, any polymer may be used in the practice of this invention. It is preferable to use polymers of low viscosity such as siloxanes, or polymer compositions containing monomers that can reduce the viscosity of the polymer composition. Systems that contain solely monomers such as amines and acid chlorides such as aryoyl chlorides or sulfonyl chlorides are also suitable for this invention. Suitable examples, such as those found in U.S. Pat. No. 5,693,227 to Costa, which is incorporated by reference in its entirety, include, but are not limited to, acid chloride, amine, isocyanate, diol, cyanate ester, bismaleimide, epoxide, acrylate, methacrylate, perflouorovinyl ether, vinyl ether, vinyl benzyl ether, nitrile, aziridine, bisbenzoxazine, bismaleimide, ethynyl compound, and polyimide.

Elastomeric polymers suitable for the invention include, but are not limited to, of polysiloxane containing hydride, methyl, phenyl, cyanoalkyl, trifluoroporpyl, trifluoromethylphenyl, difluorophenyl, trifluorophenyl, tetrafluorophenyl, pentafluorophenyl, and carboxyalkyl, 1,2-polybutadiene, 1,4-polybutadiene, carboxy-terminated polybutadiene, hydroxy-terminated polybutadiene, amino-terminated polybutadiene, epoxy-terminated polybutadiene, maleated polybutadiene, polybutadiene-acrylonitrile copolymers, polybutadiene-polyisoprene copolymers, polyisobutylene, polytetrahydrofuran, polyalkylene glycols such as polyethylene, polypropyleneglycols, polybutanediols, or block or random copolymers thereof or α,ω-2,4-toluene diisocyanate, carboxy, or amino terminated polyalkyleneglycol oligomers, aliphatic polyesterspolyetherimide, polyamide, polycarbonate, polybromostyrene, polychlorostyrene, polystyrene-co-isobutylene, allyl-terminated polyisobutylene, siloxane-isobutylene copolymer, ethyl acrylate-acrylonitrile copolymer, alkylene sulfide rubber, polynorbonene, polyoctenamer, polyethylene glycol, polypropylene glycol, polyethylene, polypropylene, polyacrylonitrile-butadiene carboxy terminated, polyvinyl acetate, polyimide ester, polyurethane-polyester copolymers, polyformal, and thermoplastic polymers such as polyetherketone, polysulfone, polyetherimide, polyimide, polyetherketone, polyethersulfone, polyamic acid, and polybisphenol-epichlorohydrin copolymer. Additional suitable examples of polymers can be found in U.S. Pat. Nos. 5,756,643, 5,670,052, 5,396,019, 5,241,039, 5,180,496, 5,177,296, 5,159,130, 5,128,439, 5,093,003, 5,055,631, 5,019,666, 5,012,036, 5,012,035, 4,990,275, 4,976,868, 4,946,594, and 4,944,880, all of which are incorporated herein by reference in their entireties.

The invention may also use monomers, polymers, additives and processes commonly found in interfacial polymerizations and the like. Suitable examples may be found in U.S. Pat. No. 5,693,227 to Costa.

Thickeners include fumed silica, acrylic polymers, cross-linked acrylic polymers, alginates carrageenan, microcrystalline cellulose, carboxymethylcellulose sodium, hydroxyethylcellulose, hydroxypropylcellulose, methylcellulose, guar and guar derivatives, organoclay, polyethylene, polyethylene oxide, polyvinylpyrrolidone, silica, water-swellable clay, and xanthan gum. Preferably, fumed or colloidal silica, polyhedral oligomeric silsesquioxanes “POSS” type fillers may be used. They may be treated to improve modify particle surface interactions by methods well known to the art. CAB-O-SIL® fumed silica is an efficient thickener in many liquid systems. See CAB-O-SIL® Fumed Silica in Cosmetic and Personal Care Products available at http://www.cabot-corp.com/cws/businesses.nsf/8969ddd26dc8427385256c2c004dad01/2a5aa4ba3348b 81785256c7a0050216b/$FILE/TD-104.pdf. CAB-O-SIL® M-5 is untreated grade while CAB-O-SIL® TS-720 treated fumed silica is fully treated with a dimethyl silicone polymer. See CAB-O-SIL® TS-720 Treated Fumed Silica, available at http://www.cabot-corp.com/cws/businesses.nsf/8969ddd26dc8427385256c2c004dad01/991dd4e548574 43485256c7a005021bd/$FILE/TSD-120b.pdf

Non-limiting examples of the material forming the porous support include polysulfone, polyether sulfone, polyacrylonitrile, cellulose ester, polypropylene, polyvinyl choride, polyvinylidene fluoride and poly(arylether) ketones (PEEK and PEKK), fluoropolymers, polysulfone, polyacrylonitrile, polyamide, polyetherimide, polyimide, fluoropolymer membranes, polybenzoxazole including functionalized (i.e. sulfonated and croslinked derivatives thereof). Other porous materials might be used as well, such as ceramics, glass and metals, in a porous configuration. Those of ordinary skill in the art will be able to make the selection from among the suitable materials in the art. Fluoropolymers, polysulfones, polyether sulfones and polyamides are generally more preferred because these materials are readily available, have desirable physical and chemical properties.

The thickness of the material forming the porous support may be between about 3 mils and about 10 mils thick, although other thicknesses may be used. For example, a one mil thick porous support permits production of higher flux films. In some cases, the porous support may be relatively thick, for example, one inch or more, where aqueous solution is applied to only one side, which is subsequently contacted with the organic solution, forming the interface at which polymerization occurs. The porous support may be reinforced by using a fabric backing or a non-woven web material. Non-limiting examples include films, sheets, and nets such as a nonwoven polyester cloth. The polymer may permeate through the pores, be attached on both sides of the support, or be attached substantially on one side of the support. Polyamide, polyphenylene sulfide and the like are typical supporting webs.

Peroxides for the curing of vinyl terminated compounds can be used. For example, dimethylaminopyridine, tetraalkyl or aryl ammonium salts or phosphonium salts are useful for chemistries involving acylation or ring opening, such as acid chloride amine reactions or amine epoxide reactions.

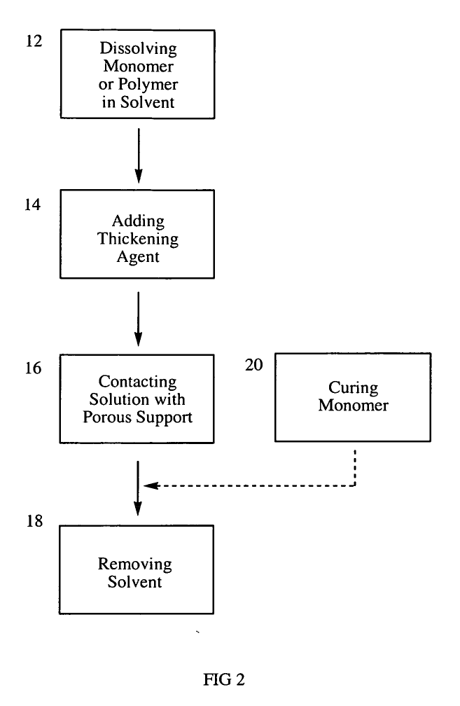

Referring to FIG. 2, the method for making a composite in accordance to the present invention is shown. In step 12, a monomer or a polymer is dissolved in a solvent to form a coating solution. In step 14, a thickening agent is added to the coating solution. In step 16, the coating solution with the thickening agent is contacted with a porous support. In step 18, the solvent in the coating solution is removed, resulting in the formation of a polymer layer as an ultra-thin film on top of the porous support. Optionally, step 20, in which curing of the monomer takes place, can be added after step 16.

### EXAMPLES

### Example 1

### Preparation of α,ω-methacryloyl-DMBPC/BPA/DDDA (49/49/2) Terpolyestercarbonate-Carbonate

A 500 mL phosgenator was charged with 1,1-bis(4′-hydroxy-3′-methylphenyl) cyclohexane, or “DMBPC” (14.5 g, 49 mmol), 2,2-bis(4-hydroxyphenyl)propane, commonly known as “bisphenol A” or “BPA” (11.2 g, 49 mmol), methylene chloride (100 mL), methacryloyl chlodide (0.63 g, 6.00 mol %), triethylamine (900 μL, 6 mol %). After stirring for 3 min, distilled water (100 mL), methyltributylammonium chloride (0.8 mL of a 75 wt % aqueous solution), dodecane dioic acid or “DDDA” (0.46 g, 2 mmol) and methylene chloride (25 mL) were added. The pH was adjusted to and maintained at 8.0 with 25 wt % NaOH while 7.0 g (70 mol % equivalence) of phosgene was added at about 0.5 g/min. The pH was ramped to 10.5 over 2 minutes and phosgene continued until 13.3 g (30 mol % excess) had been added. The polymer solution was diluted with methylene chloride (35 mL), separated from the brine, washed two times with 1N HCl and six times with distilled water. The polymer was isolated by hot water crumbing in a blender and dried overnight at 110° C. under nitrogen. The dried polymer had a Tg of 132° C. and a M.W. of 40,200 (polystyrene standards).

### Example 2 (Comparative)

The polycarbonate from Example 1 (5 g) was dissolved in N-methylpyrrolidinone (95 g). Dicumylperoxide (0.1 g) was then added. The solution was knife-cast onto a porous Gore-tex® Teflon® support (pore size=0.2 micron; porosity approximately 80%) using a of a knife gap setting of 6 mil. The coating immediately coalesced on the surface producing a highly non-uniform membrane.

### Example 3 (Inventive)

The polycarbonate from Example 1 (5 g) was dissolved in N-methylpyrrolidinone (95 g). The solution was then treated with 5 g of CAB-O-SIL® TS-720 fumed silica treated with dimethyl silicone polymer and mixed thouroughly. The solution was knife-cast onto a porous Gore-tex® Teflon® support (pore size=0.2 micron; porosity approximatley 80%) using a of a knife gap setting of 6 mils. The coating formed a uniform film on the surface of the porous support and after heating at 120° C. for 1 h to cure the resin and was cured at 120° C. to form a composite membrane. No penetration of the porous membrane to the back side was noted.

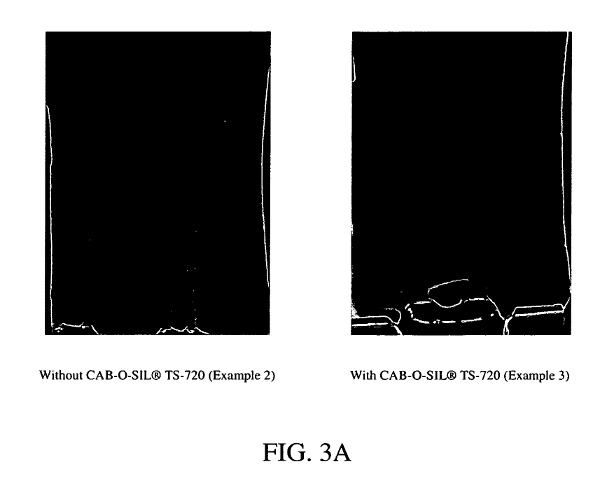

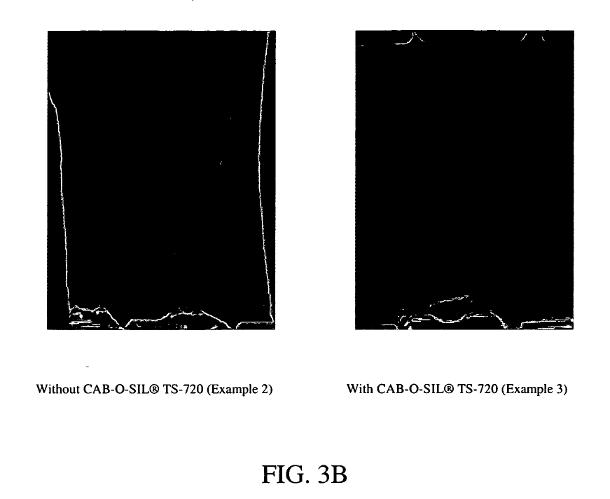

Referring to FIGS. 3A and 3B, samples of solutions of Example 2 and Example 3 coated on Teflon® and hung vertically are shown below to demonstrate the invention described herein. FIG. 3A shows the initial appearance of the composite membranes using coating solutions without CAB-O-SIL® TS-720 (Example 2) and with CAB-O-SIL® TS-720 (Example 3). FIG. 3B shows the appearance of the composite membranes after 15 minutes. Without the use of CAB-O-SIL® TS-720, the coating of polymer was not evenly prepared initially; after 15 minutes, the coating of the polymer did not stay attached to the porous support. In comparison, with the use of CAB-O-SIL® TS-720, the coating of polymer was even initially, and after 15 minutes, the coating of polymer remained attached to the porous support.

While it is apparent that the illustrative embodiments of the invention disclosed herein fulfill the objectives of the present invention, it is appreciated that numerous modifications and other embodiments may be devised by those skilled in the art. Additionally, feature(s) and/or element(s) from any embodiment may be used singly or in combination with other embodiment(s). Therefore, it will be understood that the appended claims are intended to cover all such modifications and embodiments, which would come within the spirit and scope of the present invention.

1. (canceled)

2. (canceled)

3. (canceled)

4. (canceled)

5. (canceled)

6. (canceled)

7. (canceled)

8. (canceled)

9. (canceled)

10. A method of preparing a solvent-resistant composite membrane comprising the steps of:
dissolving a monomer or a polymer in a solvent to form a coating solution;
adding a thickening agent to the coating solution;
contacting the coating solution with a porous support to form a coating; and
removing the solvent, wherein the coating has a thickness of 3 mils to 10 mils.

11. The method of claim 10, wherein the monomer is a member selected from the group consisting of acid chloride, amine, isocyanate, diol, cyanate ester, bismaleimide, epoxide, acrylate, methacrylate, perflouorovinyl ether, vinyl ether, vinyl benzyl ether, nitrile, aziridine, bisbenzoxazine, bismaleimide, ethynyl compound, and polyimide.

12. The method of claim 10, wherein the polymer is a member selected from the group consisting of polysiloxane containing hydride, methyl, phenyl, cyanoalkyl, trifluoroporpyl, trifluoromethylphenyl, difluorophenyl, trifluorophenyl, tetrafluorophenyl, pentafluorophenyl, and carboxyalkyl, 1,2-polybutadiene, 1,4-polybutadiene, carboxy-terminated polybutadiene, hydroxy-terminated polybutadiene, amino-terminated polybutadiene, epoxy-terminated polybutadiene, maleated polybutadiene, polybutadiene-acrylonitrile copolymers, polybutadiene-polyisoprene copolymers, polyisobutylene, polytetrahydrofuran, polyalkylene glycols such as polyethylene, polypropyleneglycols, polybutanediols, or block or random copolymers thereof or α,ω-2,4-toluene diisocyanate, carboxy, or amino terminated polyalkyleneglycol oligomers, aliphatic polyesterspolyetherimide, polyamide, polycarbonate, polybromostyrene, polychlorostyrene, polystyrene-co-isobutylene, allyl-terminated polyisobutylene, siloxane-isobutylene copolymer, ethyl acrylate-acrylonitrile copolymer, alkylene sulfide rubber, polynorbonene, polyoctenamer, polyethylene glycol, polypropylene glycol, polyethylene, polypropylene, polyacrylonitrile-butadiene carboxy terminated, polyvinyl acetate, polyimide ester, polyurethane-polyester copolymers, polyformal, polyetherketone, polysulfone, polyetherimide, polyimide, polyetherketone, polyethersulfone, polyamic acid, and polybisphenol-epichlorohydrin copolymer.

13. The method of claim 10, wherein the porous support is a member selected from the group consisting of polysulfone, polyether sulfone, polyacrylonitrile, cellulose ester, polypropylene, polyvinyl choride, polyvinylidene fluoride and poly(arylether) ketone, fluoropolymer, polyacrylonitrile, polyamide, polyetherimide, polyimide, fluoropolymer membrane, polybenzoxazole, ceramics in a porous configuration, glass in a porous configuration and metal in a porous configuration.

14. The method of claim 10, wherein the porous support is selected from the group consisting of fluoropolymer, polysulfone, polyether sulfone and polyamide.

15. The method of claim 10, wherein the thickening agent is a member selected from the group consisting of fumed silica, acrylic polymers, cross-linked acrylic polymer, alginates carrageenan, microcrystalline cellulose, carboxymethylcellulose sodium, hydroxyethylcellulose, hydroxypropylcellulose, methylcellulose, guar, guar derivative, organoclay, polyethylene, polyethylene oxide, polyvinylpyrrolidone, silica, water-swellable clay, and xanthan gum.

16. The method of claim 10, wherein the thickening agent is a fumed silica.

17. The method of claim 16, wherein the fumed silica is treated.

18. The method of claim 17, wherein the fumed silica is treated with dimethyl silicone polymer.

19. The method of claim 10, further comprising the step of curing the monomer or the polymer on the porous support to form a composite membrane.
